(19) United States
(12) Patent Application Publication
(10) Pub. No.: US 2025/0125373 A1
(43) Pub. Date: Apr. 17, 2025

(54) CATHODE FOR ZINC-BROMINE AQUEOUS BATTERY CONTAINING NITROGEN-DOPED MESOPOROUS CARBON MATERIAL AND METHOD FOR MANUFACTURING THE SAME

(71) Applicant: GWANGJU INSTITUTE OF SCIENCE AND TECHNOLOGY, Gwangju (KR)

(72) Inventors: Chan Ho PAK, Gwangju (KR); Jong Gyeong KIM, Gwangju (KR); Young In CHO, Gwangju (KR)

(21) Appl. No.: 18/792,517

(22) Filed: Aug. 1, 2024

(30) Foreign Application Priority Data
Oct. 13, 2023 (KR) 10-2023-0137175

(51) Int. Cl. H01M 4/62; H01M 4/02; H01M 4/04; H01M 4/24; H01M 4/26; H01M 4/583; H01M 4/66; H01M 4/72

(52) U.S. Cl. CPC H01M 4/628; H01M 4/0402; H01M 4/0471; H01M 4/24; H01M 4/26; H01M 4/583; H01M 4/663; H01M 4/72; H01M 2004/021; H01M 2004/028

(57) ABSTRACT

The present inventive concept relates to a positive electrode for a zinc-bromine aqueous battery containing a nitrogen-doped mesoporous carbon material and a manufacturing method. Coating a nitrogen-doped mesoporous carbon material on graphite felt can alter the structural and chemical properties of the positive electrode to inhibit the crossover of bromine compounds, thereby improving the battery's potential stability.

### CROSS-REFERENCE TO RELATED PATENT APPLICATION

This application claims the benefit of Korean Patent Application No. 10-2023-0137175, filed on Oct. 13, 2023, in the Korean Intellectual Property Office, the disclosure of which is incorporated herein in its entirety by reference.

### BACKGROUND

### 1. Field of the Inventive Concept

The present inventive concept relates to a positive electrode for a zinc-bromine aqueous battery containing a nitrogen-doped mesoporous carbon material and a method for manufacturing the same. More specifically, the present inventive concept relates to the positive electrode for the zinc-bromine aqueous battery in which the structural and chemical properties have been modified using the nitrogen-doped mesoporous carbon material to inhibit the crossover of bromine compounds, thereby improving the performance and stability of the battery.

### 2. Description of the Related Art

Due to the existing climate crisis and resource depletion, extensive research on renewable energy has been conducted. However, issues have arisen regarding the volatility of electricity production and the stability of supply. Therefore, large-scale energy storage systems (ESSs) that can address these issues have attracted much attention. Lithium-ion batteries have been used as the ESSs, but there is a risk of ignition. Therefore, the zinc-bromine aqueous batteries are attracting attention as one of the next-generation batteries. The zinc-bromine aqueous batteries have the advantages of high safety, long lifespan, environmental friendliness, and low cost.

The zinc-bromine aqueous battery uses the bromine redox reaction at the positive electrode. However, a drawback exists in that bromine and bromine complexes, formed at the positive electrode, cross over to the negative electrode, causing an increase in the overpotential of the positive electrode and thus reducing the battery's lifespan. Therefore, there is a need for a technology that can prevent the crossover from occurring at the positive electrode and improve the reversibility of bromine.

### SUMMARY OF THE INVENTIVE CONCEPT

The present inventive concept has been made to solve the above-described problems associated with the prior art. The first object of the present inventive concept is to provide the positive electrode for the zinc-bromine aqueous battery containing the nitrogen-doped mesoporous carbon material.

A second object of the present inventive concept is to provide the method of manufacturing the positive electrode for the zinc-bromine aqueous battery containing the nitrogen-doped mesoporous carbon material to achieve the first technical problem.

To achieve the above-described first object, the present inventive concept provides the positive electrode for the zinc-bromine aqueous battery containing the nitrogen-doped mesoporous carbon material.

To achieve the above-described second object, the present inventive concept provides the method for manufacturing the positive electrode for the zinc-bromine aqueous battery containing the nitrogen-doped mesoporous carbon material. The positive electrode for the zinc-bromine aqueous battery containing the nitrogen-doped mesoporous carbon material is manufactured by immersing graphite felt in a slurry containing a solvent, a cross-linking agent, a pore-forming agent, a carbon precursor, and a nitrogen source material, and then coating the slurry onto the graphite felt through the evaporation-induced self-assembly (EISA) method, followed by curing and pyrolysis.

According to the present inventive concept as described above, the positive electrode for the zinc-bromine aqueous battery containing the nitrogen-doped mesoporous carbon material of the present inventive concept modifies the structural and chemical properties of the graphite felt, thereby creating spaces for capturing and immobilizing bromine and bromine complexes generated during the battery charge process. Therefore, it is possible to maintain the battery performance by inhibiting the crossover of bromine. Moreover, it is possible to achieve uniform coating using the EISA method for coating the porous carbon material onto the graphite felt.

Without the need for any pretreatment, such as heat or ozone treatment, to introduce the oxygen functional groups on the electrode surface to hydrophilize the conventional hydrophobic graphite felt electrode, the present inventive concept can enhance the affinity between the positive electrode and the aqueous electrolytes due to the presence of nitrogen and oxygen species within the nitrogen-doped mesoporous carbon material.

Therefore, the present inventive concept exhibits higher performance and stability when evaluating the performance of individual batteries compared to the prior art.

### BRIEF DESCRIPTION OF THE DRAWINGS

The above and other features and advantages of the present inventive concept will become more apparent by describing in detail exemplary embodiments thereof regarding the attached drawings in which:

FIG. 1 is a flowchart illustrating a method of manufacturing the positive electrode for the zinc-bromine aqueous battery containing the nitrogen-doped mesoporous carbon material according to the preferred embodiment of the present inventive concept;

FIG. 2 shows Field Emission-Scanning Electron Microscope (FE-SEM) images according to the preferred embodiment of the present inventive concept;

FIG. 3 shows Low Mode (LM) image of FE-SEM according to the preferred embodiment of the present inventive concept;

FIG. 4 depicts graphs showing the thickness measured from the Low Mode images of FE-SEM according to the preferred embodiment of the present inventive concept;

FIG. 5 shows the pore size distribution according to the preferred embodiment of the present inventive concept;

FIG. 6 is a graph showing the measured charge-discharge performance according to the preferred embodiment of the present inventive concept;

FIG. 7 is a graph showing the results of Raman spectroscopy according to the preferred embodiment of the present inventive concept;

FIG. 8 depicts images showing the results of hydrophilicity evaluation according to the preferred embodiment of the present inventive concept;

FIG. 9 is a graph showing the results of the charge-discharge test according to the preferred embodiment of the present inventive concept;

FIG. 10 depicts graphs showing the results of long-term stability and performance tests according to the preferred embodiment of the present inventive concept;

FIG. 11 shows SEM images depending on the pyrolysis temperature according to the preferred embodiment of the present inventive concept;

FIG. 12 depicts graphs showing the pore size distribution depending on the pyrolysis temperature according to the preferred embodiment of the present inventive concept;

FIG. 13 is a graph showing the results of Raman spectroscopy depending on the pyrolysis temperature according to the preferred embodiment of the present inventive concept;

FIG. 14 is a graph showing the results of the charge-discharge test depending on the pyrolysis temperature according to the preferred embodiment of the present inventive concept; and

FIG. 15 depicts graphs showing the results of long-term stability and performance tests depending on the pyrolysis temperature according to the preferred embodiment of the present inventive concept.

### DETAILED DESCRIPTION OF THE INVENTIVE CONCEPT

As the present inventive concept allows for various changes and numerous embodiments, particular embodiments will be illustrated in the drawings and described in detail in the written description. However, this is not intended to limit the present inventive concept to modes of practice, and it is to be appreciated that all changes, equivalents, and substitutes that do not depart from the spirit and technical scope of the present inventive concept are encompassed in the present inventive concept.

Unless defined otherwise, all terms used herein, including technical or scientific terms, have the same meaning as those generally understood by those skilled in the art to which the present inventive concept pertains. It will be further understood that terms defined in dictionaries that are commonly used should be interpreted as having meanings consistent with their meanings in the context of the relevant art and should not be interpreted as having ideal or excessively formal meanings unless clearly defined in the present application.

After this, various embodiments of the present inventive concept will be described in more detail regarding the accompanying drawings.

### Examples

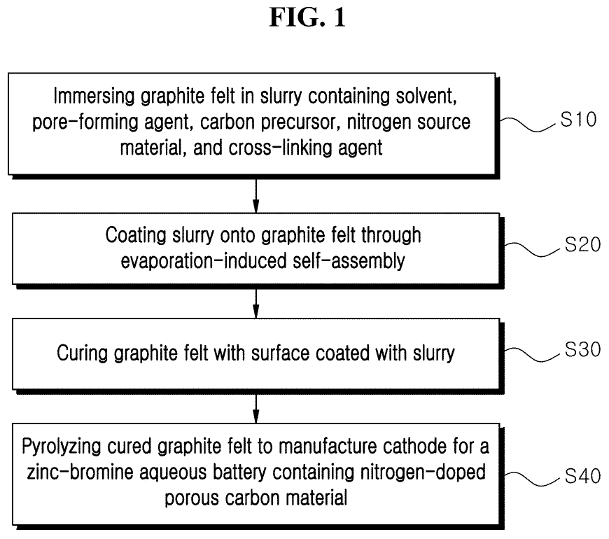

FIG. 1 is a flowchart illustrating a method of manufacturing the positive electrode for the zinc-bromine aqueous battery containing the nitrogen-doped mesoporous carbon material according to the preferred embodiment of the present inventive concept.

Referring to FIG. 1, the positive electrode for the zinc-bromine aqueous battery containing the nitrogen-doped mesoporous carbon material may be manufactured by the method comprising: a first step (S10) of immersing graphite felt in the slurry containing the solvent, pore-forming agent, carbon precursor, nitrogen source material, and cross-linking agent; a second step (S20) of coating the slurry onto the resulting graphite felt through the evaporation-induced self-assembly method; a third step (S30) of curing the graphite felt with the surface being coated with the slurry; and a fourth step (S40) of pyrolyzing the cured graphite felt to manufacture the positive electrode for the zinc-bromine aqueous battery containing the nitrogen-doped mesoporous carbon material.

In the first step (S10), the graphite felt is immersed and mixed in the slurry containing the solvent, pore-forming agent, carbon precursor, nitrogen source material, and cross-linking agent.

In this case, the amount of the added pore-forming agent may range from 2.5 wt % to 10.9 wt % relative to the amount of solvent, more preferably in the range from 4.1 wt % to 6.7 wt %. Suppose the amount of the pore-forming agent is less than 2.5 wt % relative to the amount of solvent. In that case, the formation of pores within the carbon material may be insufficient to achieve nitrogen doping, or the capturing of bromine complexes within the pores during battery operation is not facilitated, making it difficult to inhibit the crossover of bromine. Suppose the amount of the pore-forming agent exceeds 10.9 wt %. In that case, the formation of pores within the carbon material may be excessive, leading to excessive bromine capture and potentially causing difficulties in battery operation. Therefore, if the amount of the pore-forming agent added is in the range from 2.5 wt % to 10.9 wt %, the formation of pores is appropriate, thereby improving the battery performance.

The pore-forming agent may preferably comprise at least one of Pluronic F-127, P123, and F108, but is not limited to it, and any substance capable of forming a first type of pores among two kinds of mesopores in the carbon material can be used.

The first type of pores may have an average pore diameter ranging from 2.8 nm to 3.3 nm, and an average pore diameter of 3.0 may be desirable for improving the battery performance. However, the average pore diameter may vary depending on measurement equipment and range differences. Thus, if the pores have an average pore diameter ranging from 2.8 nm to 3.3 nm and can adsorb bromine and bromine complexes, the formation of these pores is considered significant, which can be regarded as the first type of pores.

The amount of the carbon precursor added may be in the range from 2.0 wt % to 10.0 wt % relative to the amount of solvent, more preferably in the range from 3.3 wt % to 5.0 wt %. If the amount of the carbon precursor added is less than 2.0 wt % relative to the amount of solvent, the quantity of the precursor may be insufficient to form the mesoporous carbon material. If the amount of the carbon precursor added exceeds 10.0 wt % relative to the amount of solvent, the formation of pores within the carbon material may not be facilitated. Therefore, the amount of the carbon precursor added should be from 2.0 wt % to 10.0 wt %.

The carbon precursor may preferably comprise at least one of tannic acid, gallic acid, and syringic acid, but is not limited to it.

The added nitrogen source material may range from 1.2 wt % to 6.7 wt % relative to the amount of solvent, preferably from 2.0 wt % to 3.0 wt %. If the nitrogen source material is added within this range and carbonized, it can form a second type of pore among two kinds of mesopores in the carbon material. The second type of pores may have an average pore diameter ranging from 5.3 nm to 6.0 nm, more preferably an average pore diameter of 5.7 nm. However, the average pore diameter may vary depending on measurement equipment and range differences. Thus, if the pores have an average pore diameter ranging from 5.3 nm to 6.0 nm and can capture bromine and bromine complexes, the formation of these pores is considered significant, and they can be regarded as the second type of pores.

Moreover, the nitrogen species formed by the carbonization of the nitrogen source material can improve the hydrophilicity of the positive electrode. Compared to the prior art, no additional pretreatment is required for this process, making it simple and efficient. Furthermore, the increased hydrophilicity can improve the battery's potential stability.

The nitrogen source material may preferably comprise at least one of melamine, urea, guanine, and amino acids, but is not limited to it, and any organic material containing nitrogen can be used as the nitrogen source material.

The amount of the cross-linking agent added may be the same as that of the carbon precursor. The amount of cross-linking agent added may range from 2.0 wt % to 10 wt % relatives to the amount of solvent, preferably from 3.3 wt % to 5.0 wt %. If the amount of the cross-linking agent is less than 2.0 wt %, there may be difficulties in forming the nitrogen-doped mesoporous carbon material. If the amount of cross-linking agent exceeds 10 wt %, excessive binding of materials within the slurry may occur, leading to decreased battery performance.

Therefore, the cross-linking agent added may be between 2.0 wt % and 10 wt %.

The cross-linking agent may comprise any one selected from the group consisting of formaldehyde and a metal salt, and the metal salt may preferably include at least one of zinc chloride, zinc bromide, zinc acetate, zinc acetylacetonate, zinc benzoate, and zinc nitrate, but is not limited to it.

The slurry satisfies the following Equation 1 within the respective ranges:

$$X \% = \frac{\begin{matrix}Solid mass ( Pore - forming agent + \\ Carbon precursor + Nitrogen source material )\end{matrix}}{\begin{matrix}Solid mass + \\ Cross - linking agent mass + Solvent mass\end{matrix}} * 100 \% \qquad [ Equation 1 ]$$

In Equation 1, X represents the solid content used to manufacture the positive electrode. Ethanol is a desirable solvent, but it is not limited to it.

In Equation 1, the value of X should be within the range of 8% to 15%, preferably between 10% to 12%. Suppose the value of X in Equation 1 is less than 5%. In that case, the slurry may not contain sufficient materials to capture the bromine complex, making it difficult to improve the battery performance. Suppose the value of X in Equation 1 exceeds 15%. In that case, a large amount of solid content may be introduced into the slurry, leading to an inadequate cross-linking or an excessive formation of carbon layers on the graphite felt, which may interfere with the operation of the battery.

Therefore, if the value of X in Equation 1 ranges from 8% to 15%, the battery's performance and stability can be improved.

After the graphite felt is immersed in the slurry during the first step (S10), the slurry is coated onto the resulting graphite felt through the evaporation-induced self-assembly method in the second step (S20). Using the evaporation-induced self-assembly method, each component spontaneously binds into an organized structure, allowing the nitrogen-containing slurry to be coated onto the graphite felt through a simple process. The coating layer formed through the evaporation-induced self-assembly method exhibits lower surface roughness and unevenness than the coating layer formed on the positive electrode through the conventional immersion method, resulting in a more uniform coating.

The graphite felt is coated with the slurry in the second step (S20) and cured in the third step (S30).

In the fourth step (S40), the graphite felt cured during the third step (S30) is subjected to pretreatment and pyrolysis to manufacture the positive electrode for the zinc-bromine aqueous battery containing the nitrogen-doped mesoporous carbon material.

The pyrolysis temperature may preferably be between 700° C. and 900° C., more preferably between 750° C. and 850° C., and even more preferably around 800° C. Manufacturing the positive electrode for the zinc-bromine aqueous battery containing the nitrogen-doped mesoporous carbon material within the above pyrolysis temperature range can further improve the battery performance.

The positive electrode formed through the pyrolysis can create mesopores in the carbon material, including two types of mesopores consisting of the first types of pores and the second types of pores. More specifically, the positive electrode may include many mesopores: the first type of pores with an average pore diameter of 3 nm and the second type of pores with an average pore diameter of 5.7 nm.

The positive electrode formed through the pyrolysis may contain oxygen and nitrogen species in the 2 at % to 4 at %, respectively. The hydrophilicity can be improved without pretreatment with the oxygen and nitrogen species formed on the positive electrode.

The nitrogen species within the positive electrode may preferably contain pyridine nitrogen in an amount of more than 41 at %. If the pyridine nitrogen is included in an amount of more than 41 at %, it facilitates the adsorption of bromine and bromine complexes, thereby inhibiting the crossover of bromine during battery operation.

### Preparation Example 1: Preparation of the Positive Electrode Containing 5% Nitrogen-Doped Mesoporous Carbon Material

1.5 g of F127 as the pore-forming agent, 1.2 g of tannic acid as the carbon precursor, 0.75 g of melamine as the nitrogen source material, and 1.2 g of formaldehyde as the cross-linking agent was added to 60 g of ethanol solvent to form the slurry, and then the graphite felt was immersed in the resulting slurry, followed by mixing at 500 rpm for 3 hours. Subsequently, the evaporation-induced self-assembly method was carried out at room temperature for more than 12 hours to ensure complete solvent evaporation, followed by curing at 100° C. for 24 hours, pretreatment at 450° C. for 3 hours, and pyrolysis at 800° C. for 2 hours under an argon atmosphere, thereby preparing the positive electrode for the zinc-bromine aqueous battery containing the nitrogen-doped mesoporous carbon material.

### Preparation Example 2: Preparation of the Positive Electrode Containing 8% Nitrogen-Doped Mesoporous Carbon Material

Under the same conditions as in Preparation Example 1, except that 2.5 g of F127, 2 g of tannic acid, 1.2 g of melamine, and 1.2 g of formaldehyde were contained in the slurry, the positive electrode for the zinc-bromine aqueous battery containing the nitrogen-doped mesoporous carbon material was prepared.

### Preparation Example 3: Preparation of the Positive Electrode Containing 10% Nitrogen-Doped Mesoporous Carbon Material

Under the same conditions as in Preparation Example 1, except that 3 g of F127, 2.5 g of tannic acid, 1.5 g of melamine, and 2.5 g of formaldehyde were contained in the slurry, the positive electrode for the zinc-bromine aqueous battery containing the nitrogen-doped mesoporous carbon material was prepared.

### Preparation Example 4: Preparation of the Positive Electrode Containing 12% Nitrogen-Doped Mesoporous Carbon Material

Under the same conditions as in Preparation Example 1, except that 4 g of F127, 3 g of tannic acid, 1.8 g of melamine, and 3 g of formaldehyde were contained in the slurry, the positive electrode for the zinc-bromine aqueous battery containing the nitrogen-doped mesoporous carbon material was prepared.

### Preparation Example 5: Preparation of the Positive Electrode Containing 15% Nitrogen-Doped Mesoporous Carbon Material

Under the same conditions as in Preparation Example 1, except that 4.5 g of F127, 4 g of tannic acid, 2.8 g of melamine, and 4 g of formaldehyde were contained in the slurry, the positive electrode for the zinc-bromine aqueous battery containing the nitrogen-doped mesoporous carbon material was prepared.

### Preparation Example 6: Preparation of the Positive Electrode Containing 20% Nitrogen-Doped Mesoporous Carbon Material

Under the same conditions as in Preparation Example 1, except that 6.5 g of F127, 6 g of tannic acid, 4 g of melamine, and 6 g of formaldehyde were contained in the slurry, the positive electrode for the zinc-bromine aqueous battery containing the nitrogen-doped mesoporous carbon material was prepared.

### Preparation Example 7: Preparation of the Positive Electrode Containing 8% Nitrogen-Doped Mesoporous Carbon Material

Under the same conditions as in Preparation Example 2, except that the pyrolysis was conducted at 700° C., the positive electrode for the zinc-bromine aqueous battery containing the nitrogen-doped mesoporous carbon material was prepared.

### Preparation Example 8: Preparation of the Positive Electrode Containing 10% Nitrogen-Doped Mesoporous Carbon Material

Under the same conditions as in Preparation Example 3, except that the pyrolysis was conducted at 700° C., the positive electrode for the zinc-bromine aqueous battery containing the nitrogen-doped mesoporous carbon material was prepared.

### Preparation Example 9: Preparation of the Positive Electrode Containing 12% Nitrogen-Doped Mesoporous Carbon Material

Under the same conditions as in Preparation Example 4, except that the pyrolysis was conducted at 700° C., the positive electrode for the zinc-bromine aqueous battery containing the nitrogen-doped mesoporous carbon material was prepared.

### Preparation Example 10: Preparation of the Positive Electrode Containing 8% Nitrogen-Doped Mesoporous Carbon Material

Under the same conditions as in Preparation Example 2, except that the pyrolysis was conducted at 900° C., the positive electrode for the zinc-bromine aqueous battery containing the nitrogen-doped mesoporous carbon material was prepared.

### Preparation Example 11: Preparation of the Positive Electrode Containing 10% Nitrogen-Doped Mesoporous Carbon Material

Under the same conditions as in Preparation Example 3, except that the pyrolysis was conducted at 900° C., the positive electrode for the zinc-bromine aqueous battery containing the nitrogen-doped mesoporous carbon material was prepared.

### Preparation Example 12: Preparation of the Positive Electrode Containing 12% Nitrogen-Doped Mesoporous Carbon Material

Under the same conditions as in Preparation Example 4, except that the pyrolysis was conducted at 900° C., the positive electrode for the zinc-bromine aqueous battery containing the nitrogen-doped mesoporous carbon material was prepared.

### Comparative Example

Pure graphite felt without surface treatment was used as the positive electrode.

### Experimental Example 1

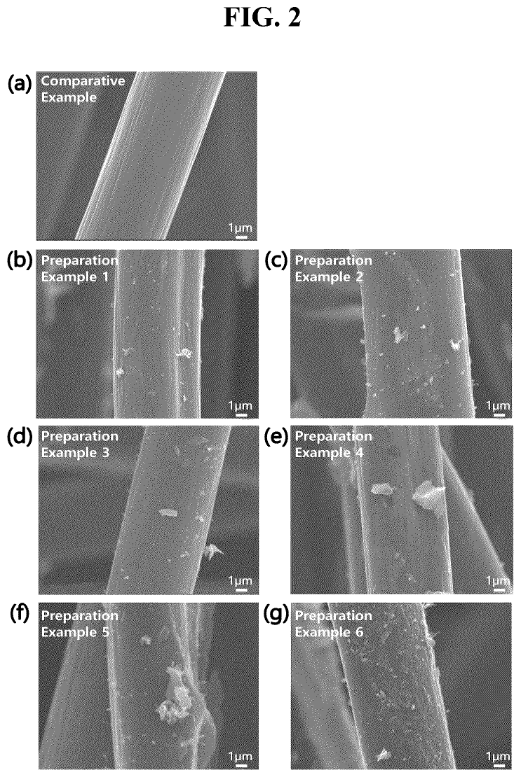

FIG. 2 shows FM-SEM images of the Comparative Example and Preparation Examples.

Referring to FIG. 2, (a) represents the Comparative Example, and (b) to (g) represent Preparation Examples 1 to 6, respectively. Comparing the Comparative Example and the Preparation Examples, (a) shows that the pure graphite felt cathode has a smooth fiber surface, while (b) to (g) show that the positive electrodes containing nitrogen-doped mesoporous carbon materials have substances bound to the fiber surface within the graphite felt. Therefore, it has been confirmed that the nitrogen-doped mesoporous carbon material is attached to the graphite felt in the Preparation Examples.

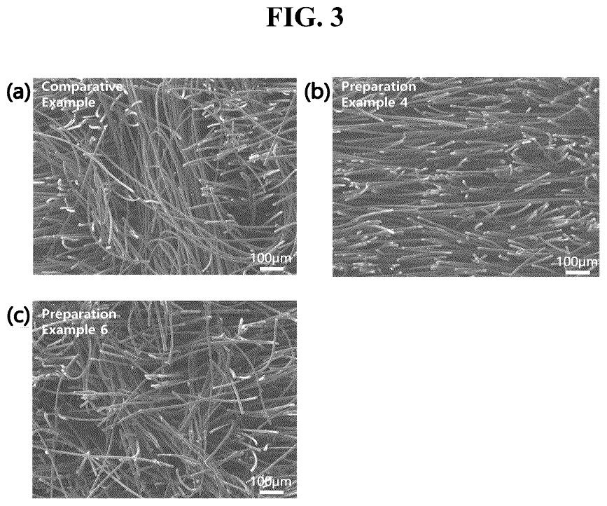

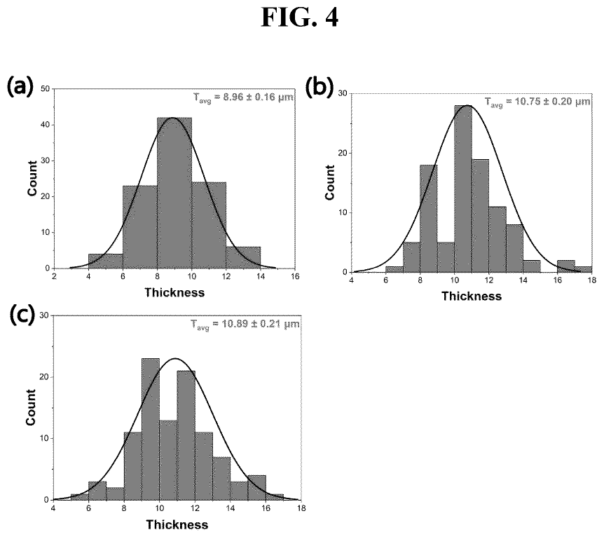

FIG. 3 shows Low Mode images of FE-SEM of the Comparative Example and Preparation Examples 4 and 6, and FIG. 4 depicts graphs showing the thickness measured from the images of FIG. 3.

Referring to FIG. 3, Preparation Examples 4 and 6 had denser surfaces compared to the Comparative Example. This is attributed to the carbon layers formed on the graphite felt in Preparation Examples 4 and 6.

Referring to FIG. 4, these graphs show that the average thickness of Preparation Examples 4 and 6 is approximately 10.75 μm and approximately 10.89 μm, respectively, compared to that of the Comparative Example, which is approximately 8.96 μm. This indicates that the average thickness of Preparation Examples 4 and 6 is greater than that of the Comparative Example. Therefore, as observed in FIG. 3, the carbon layers were formed on the graphite felt in Preparation Examples 4 and 6.

### Experimental Example 2

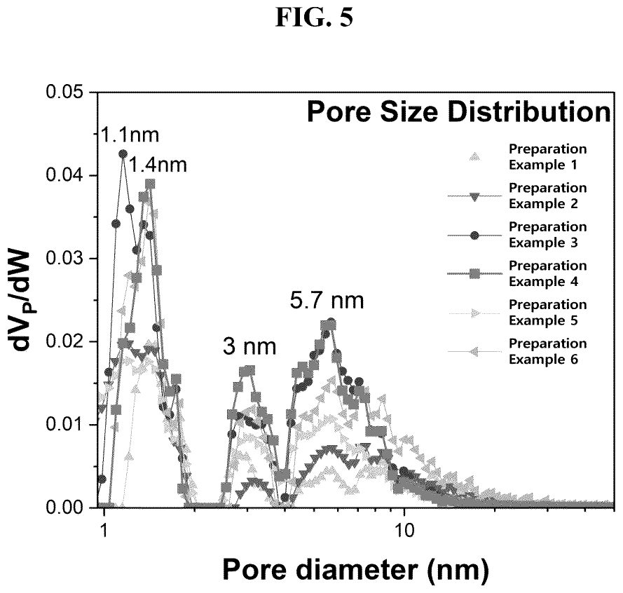

Table 1 and FIG. 5 give the specific surface areas and pore sizes of the Preparation Examples.

TABLE 1

| | Surface | Mesopore | | | | |
|---|---|---|---|---|---|---|
| | Area | Diameter | V_{micro} | Vₘₑₛₒ | V_{macro} | V_{T} |
| | (m²/g) | (nm) | (cm³/g) | (cm³/g) | (cm³/g) | (cm³/g) |
| Preparation | 68.4 | 3 nm, | 0.021 | 0.061 | 0.003 | 0.085 |
| Example 1 | | 5.7 nm | | | | |
| Preparation | 75.2 | | 0.024 | 0.062 | 0.003 | 0.089 |
| Example 2 | | | | | | |
| Preparation | 139.0 | | 0.040 | 0.100 | 0.002 | 0.142 |
| Example 3 | | | | | | |
| Preparation | 131.7 | | 0.040 | 0.081 | 0.002 | 0.123 |
| Example 4 | | | | | | |
| Preparation | 78.8 | | 0.021 | 0.064 | 0.003 | 0.088 |
| Example 5 | | | | | | |
| Preparation | 142.5 | | 0.043 | 0.128 | 0.019 | 0.190 |
| Example 6 | | | | | | |
| Comparative | 2.8 | — | 0.0003 | 0.0040 | 0.0009 | 0.0052 |
| Example | | | | | | |

Referring to Table 1 and FIG. 5, when comparing the pore sizes of Preparation Examples 1 to 6 based on nitrogen adsorption data, it can be observed that mesopores were the most abundant, with a significant presence of mesopores of 3 nm and 5.7 nm. It is estimated that the 3 nm pores were formed by the pore-forming agent F127, while the carbonization of tannic acid formed the 5.7 nm pores.

In contrast, the pure graphite felt of the Comparative Example exhibited almost no pores, and its specific surface area was 2.8 m²/g, which is significantly lower than Preparation Examples 1 to 6, which have specific surface areas ranging from a minimum of 68.4 m²/g to a maximum of 142.5 m²/g.

Therefore, Table 1 and FIG. 5 show that Preparation Examples 1 to 6 containing nitrogen-doped porous carbon materials have mesopores, resulting in excellent specific surface areas compared to the Comparative Example.

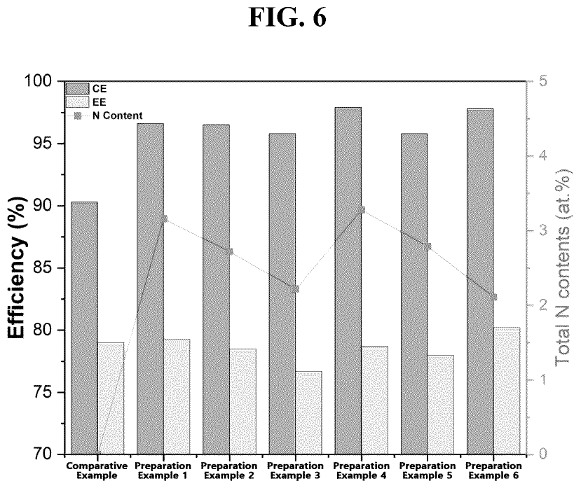

FIG. 6 is a graph showing the measured charge-discharge performance of the present inventive concept's Comparative Example and Preparation Examples. In the experiments, zinc-bromine aqueous batteries were prepared with 2.8 M ZnBr₂ used as an electrolyte, and their charge-discharge performance was measured by repeating 100 cycles under the conditions of a current density of 20 mA/cm² and a charge capacity of 2 mAh/cm². Subsequent battery performance tests were conducted under the same experimental conditions.

Referring to FIG. 6, the Coulombic efficiencies (CE) of Preparation Examples 1 to 6 were measured to be over 95%, demonstrating excellent charging efficiency, compared to the Comparative Example, which had the Coulombic efficiency of approximately 90%. Moreover, the energy efficiency (EE) of the Comparative Example was approximately 77%, while Preparation Examples 2 to 5 exhibited lower values of EE compared to the Comparative Example.

Therefore, the measured coulombic efficiency and energy efficiency indicate that the use of the cathodes for zinc-bromine aqueous batteries containing nitrogen-doped porous carbon materials in the range from 8% to 15%, which correspond to Preparation Examples 2 to 5, can improve the battery's charge-discharge performance.

Furthermore, the measurement of N contents revealed that Preparation Examples 1 to 6 had different N contents, indicating no clear tendency between the efficiency and N contents. However, compared to the Comparative Example without nitrogen, Preparation Examples 1 to 6 exhibited superior Coulombic efficiency and energy efficiency, indicating that nitrogen on the positive electrode can enhance the battery performance. The precise measurements of nitrogen are shown in Table 2 below.

TABLE 2

| | XPS (at %) | | |
|---|---|---|---|
| | C | O | N |
| Preparation Example 1 | 93.63 | 3.21 | 3.16 |
| Preparation Example 2 | 95.06 | 2.22 | 2.72 |
| Preparation Example 3 | 95.35 | 2.44 | 2.22 |
| Preparation Example 4 | 93.90 | 2.82 | 3.28 |
| Preparation Example 5 | 94.20 | 3.01 | 2.79 |
| Preparation Example 6 | 94.70 | 3.18 | 2.11 |
| Comparative Example | 97.42 | 2.58 | — |

Table 2 above represents the X-ray Photoelectron Spectroscopy (XPS) analysis results for the Comparative Example and Preparation Examples 1 to 6. It can be seen from Table 2 that both carbon species and oxygen species are present on the graphite felts of the Comparative Example and Preparation Examples 1 to 6. In addition, it was confirmed that the nitrogen species was present in Preparation Examples 1 to 6, unlike the Comparative Example. At this time, the nitrogen species in Preparation Examples 1 to 6 were measured to be 2 at % to 3 at % relative to the total.

TABLE 3

| | XPS N 1s (at %) | | | |
|---|---|---|---|---|
| | Oxidized N | Quaternary N | Pyrrolic N | Pyridinic N |
| | [402.4 eV] | [401 eV] | [400 eV] | [398.2 eV] |
| Preparation | 4.47 | 32.15 | 21.30 | 42.07 |
| Example 1 | | | | |
| Preparation | 3.61 | 32.86 | 21.34 | 42.19 |
| Example 2 | | | | |
| Preparation | 3.97 | 32.70 | 21.53 | 41.80 |
| Example 3 | | | | |
| Preparation | 4.58 | 32.74 | 21.52 | 41.15 |
| Example 4 | | | | |
| Preparation | 4.54 | 33.18 | 21.27 | 41.01 |
| Example 5 | | | | |
| Preparation | 4.12 | 32.50 | 21.46 | 41.92 |
| Example 6 | | | | |

To further analyze the nitrogen species in Table 2, XPS N 1s analysis was performed and presented in Table 3. It was observed that Preparation Examples 1 to 6 contained more than 41 at % of pyridinic N. Pyridine nitrogen exhibits excellent properties for the adsorption of bromine and bromine compounds.

Therefore, FIG. 6, Table 2 and Table 3 show that Preparation Examples 1 to 6, containing more than 41 at % of pyridine nitrogen, can adsorb bromine and bromine complexes generated during battery operation. This helps inhibit the crossover of bromine, thereby improving the electrodes' performance.

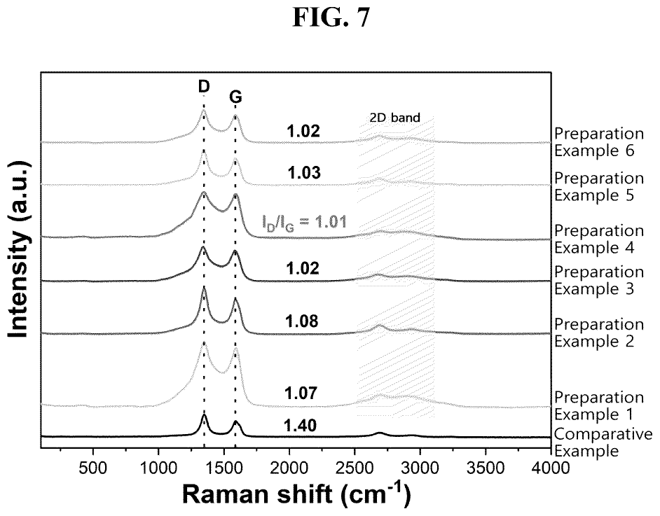

FIG. 7 is a graph showing the results of Raman spectroscopy for the Comparative Example and Preparation Examples of the present inventive concept.

Referring to FIG. 7, Preparation Examples 1 to 6 exhibited peaks in the 2D band, whereas the Comparative Example exhibited peaks with different shapes and intensities in the 2D band. Therefore, it can be inferred that the positive electrodes containing nitrogen-doped mesoporous carbon materials of Preparation Examples 1 to 6 have different surface structures than the pure graphite felt cathode of the Comparative Example.

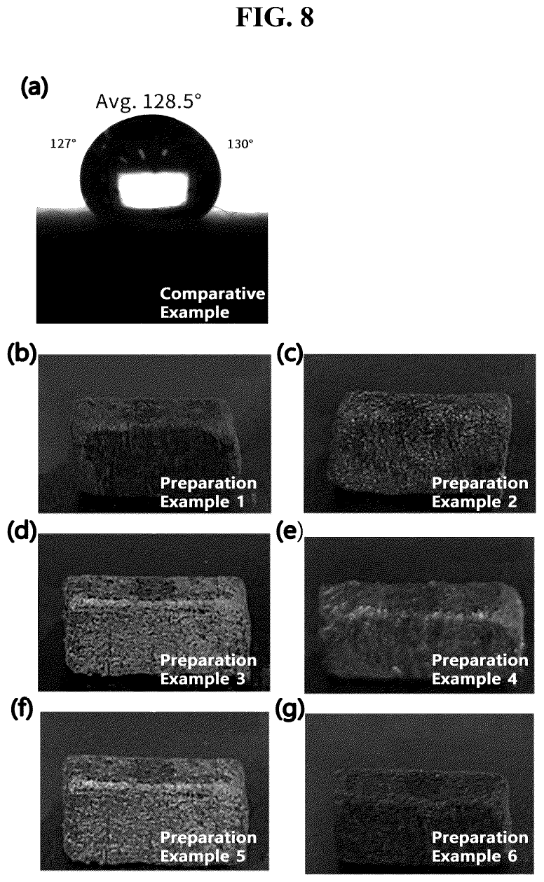

FIG. 8 depicts images showing the results of hydrophilicity evaluation for the Comparative Example and Preparation Examples of the present inventive concept.

Referring to FIG. 8, (a) represents the Comparative Example, (b) to (g) represents Preparation Examples 1 to 6, respectively, and these images were captured after the addition of water for hydrophilicity experiments.

The pure graphite felt in (a) had an average contact angle of 128.5°, indicating strong hydrophobicity. Thus, it could not absorb water but instead formed droplets on its surface. On the contrary, the graphite felts in (b) to (g) completely absorbed water within about 2 seconds after adding water, preventing water droplets from forming on the surface and making it impossible to measure the contact angle, indicating high hydrophilicity.

Therefore, FIG. 8 shows that the graphite felt coated with the nitrogen-doped porous carbon material modifies the electrode's properties from hydrophobic to hydrophilic without the need for any pretreatment due to the presence of oxygen and nitrogen species, resulting in excellent wettability.

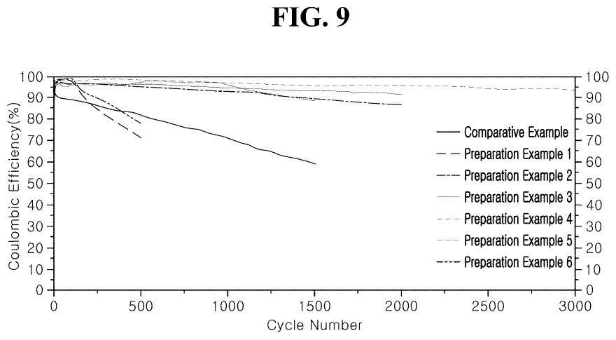

FIG. 9 is a graph showing the charge-discharge test results for the Comparative and Preparation Examples of the present inventive concept.

Referring to FIG. 9, the Comparative Example exhibited a sharp decrease in coulombic efficiency, maintaining the charge-discharge efficiency up to 1500 cycles. Moreover, Preparation Examples 1 and 6 maintained their initial Coulombic efficiency but experienced a sharp decrease starting from about 200 cycles, maintaining the charge-discharge efficiency up to 500 cycles.

On the contrary, Preparation Examples 2 to 5 maintained the Coulombic efficiency of over 80% up to about 2000 cycles. Preparation Example 4 maintained the Coulombic efficiency of over 95% up to 3000 cycles, demonstrating the most outstanding performance.

Therefore, it can be understood that the positive electrode for the zinc-bromine aqueous batteries containing the nitrogen-doped mesoporous carbon material in the range from 8% to 15% on the graphite felts, which correspond to Preparation Examples 2 to 5, exhibits excellent charge-discharge performance. When the nitrogen-doped mesoporous carbon material is contained at a concentration of 12%, it demonstrates the most outstanding performance.

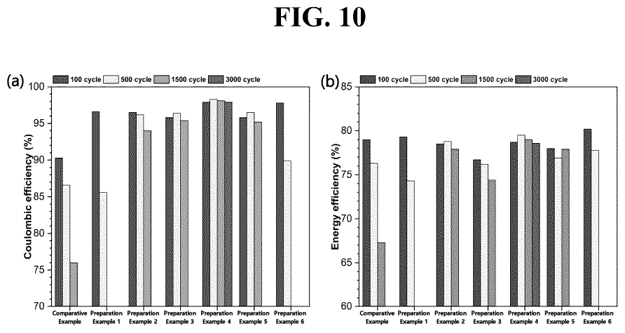

FIG. 10 depicts graphs showing the results of long-term stability and performance tests for the Comparative Example, and Preparation Examples of the present inventive concept, and the results from FIG. 10 are summarized in Table 4 below.

TABLE 4

| Average | | Prep. | Prep. | Prep. | Prep. | Prep. | Prep. |
|---|---|---|---|---|---|---|---|
| for 100 | Comp. | Example | Example | Example | Example | Example | Example |
| cycles | Example | 1 | 2 | 3 | 4 | 5 | 6 |
| Coulombic | 90.3% | 96.6% | 96.5% | 95.8% | 97.9% | 95.8% | 97.8% |
| efficiency | (76.0%) | (85.6%) | (94.0%) | (95.4%) | (97.9%) | (95.2%) | (89.9%) |
| | 1500 cycles | 500 cycles | 1500 cycles | 1500 cycles | 3000 cycles | 1500 cycles | 500 cycles |
| Energy | 79.0% | 79.3% | 78.5% | 76.7% | 78.7& | 78.0% | 80.2% |
| efficiency | (67.3%) | (74.3%) | (77.9%) | (74.4%) | (78.6%) | (77.9%) | (77.8%) |
| | 1500 cycles | 500 cycles | 1500 cycles | 1500 cycles | 3000 cycles | 1500 cycles | 500 cycles |

Referring to FIG. 10 and Table 4, (a) represents the measured coulombic efficiency, and (b) represents the measured energy efficiency.

Referring to (a) in FIG. 10, the Coulombic efficiency of Preparation Examples 1 to 6 was higher than that of the Comparative Example. The Comparative Example had the average Coulombic efficiency of 90.3 over the initial 100 cycles, but after 1500 cycles, the average Coulombic efficiency decreased to 76.0%, a decrease of 14.3%. On the contrary, Preparation Example 4, which showed the highest value in FIG. 9, had the average Coulombic efficiency of 97.9% over the initial 100 cycles, demonstrating a higher efficiency than the Comparative Example, and maintained its initial Coulombic efficiency value even after 3000 cycles, which is twice that of the Comparative Example. Moreover, Preparation Examples 2, 3, and 5 also had the average Coulombic efficiency values of over 95% during the initial 100 cycles, which were higher than the Comparative Example. Furthermore, their average Coulombic efficiency values remained above 94% after 1500 cycles, indicating excellent performance. On the contrary, Preparation Examples 1 and 6 exhibited the average Coulombic efficiency values of over 96% during the initial 100 cycles, which were excellent. Still, the Coulombic efficiency was measured only up to 500 cycles.

(b) represents a graph showing the energy efficiency of Preparation Examples 1 to 6, which is superior to the Comparative Example. The Comparative Example had the average energy efficiency of 79.0% after the initial 100 cycles, but after 1500 cycles, the average energy efficiency decreased to 67.3%, a decrease of 11.7%. On the contrary, Preparation Example 4 had the average energy efficiency of 78.7% after the initial 100 cycles, 0.3% lower than the Comparative Example. However, even after 3000 cycles, twice the number of cycles of the Comparative Example, the energy efficiency remained almost unchanged at 78.6%. Similarly, Preparation Examples 1 to 6 exhibited the average energy efficiency slightly higher or lower than the Comparative Example after the initial 100 cycles. Still, after repeated cycles, their average energy efficiency was superior to that of the comparative Examples.

Therefore, FIG. 10 and Table 4 show that Preparation Examples 2 to 5 perform superiorly, and Preparation Example 4 has the most outstanding performance and long-term stability.

### Experimental Example 3

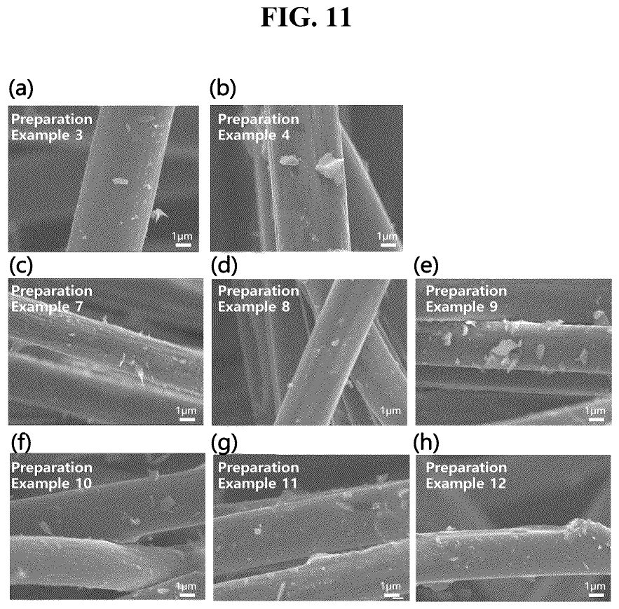

FIG. 11 shows SEM images of the Preparation Examples depending on the pyrolysis temperature of the present inventive concept.

Referring to FIG. 11, similar shapes of the nitrogen-doped mesoporous carbon materials formed on the graphite felts are observed for samples (a) and (b) pyrolyzed at 800° C., samples (c) to (e) pyrolyzed at 700° C., and samples (f) to (h) pyrolyzed at 900° C. Therefore, it can be concluded that the nitrogen-doped mesoporous carbon material having similar shapes is formed on the graphite felt at the pyrolysis temperature ranging from 700° C. to 900° C.

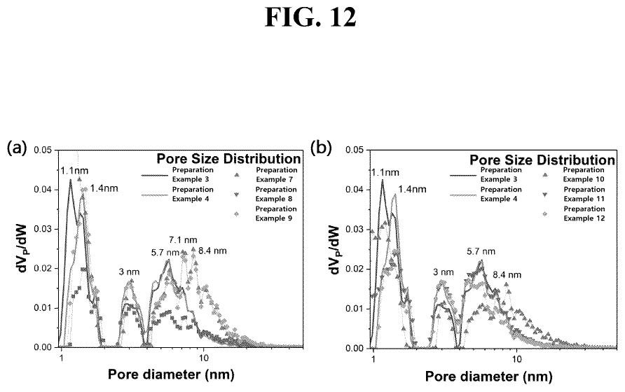

FIG. 12 depicts graphs showing the pore size distribution depending on the pyrolysis temperature of the present inventive concept.

Referring to FIG. 12, based on the pyrolysis temperature of 800° C., (a) represents a graph showing the pore distribution formed depending on the ratio of nitrogen-doped mesoporous carbon material at the pyrolysis temperature of 700° C., and (b) represents a graph showing the pore distribution formed depending on the ratio of nitrogen-doped mesoporous carbon material at the pyrolysis temperature of 900° C.

It can be seen from (a) of FIG. 12 that Preparation Examples 7 to 9 exhibit the pores of 7.1 nm and 8.4 nm in addition to the mesopores of 3 nm and 5.7 nm, which are observed in Preparation Examples 3 and 4 pyrolyzed at 800° C. Moreover, it can be seen from (b) of FIG. 12 that Preparation Examples 10 to 12 exhibit the mesopores of 8.4 nm and the mesopores of 3 nm and 5.7 nm.

Therefore, at the pyrolysis temperature ranging from 700° C. to 900° C., mesopores of 3 nm and 5.7 nm are consistently observed in abundance, which can improve the battery's performance and stability. In addition, mesopores of different sizes allow for the adjustment of the specific surface area depending on the temperature.

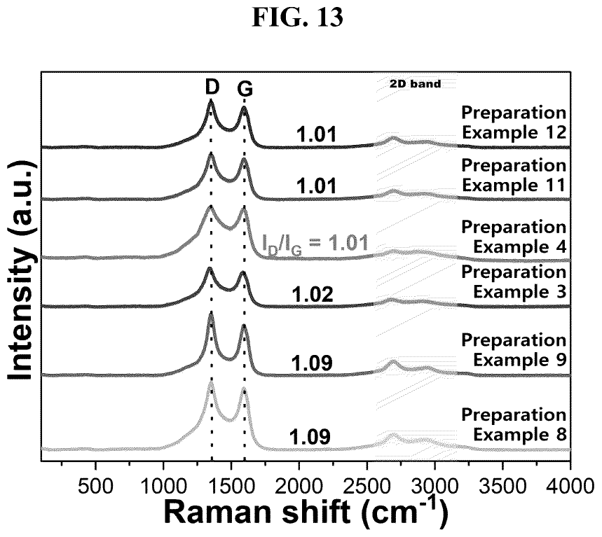

FIG. 13 is a graph showing the results of Raman spectroscopy for the Preparation Examples depending on the pyrolysis temperature of the present inventive concept.

Regarding FIG. 13, similar peaks were observed in the 2D band in Preparation Examples 3, 4, 8, 9, 11, and 12. Moreover, the electrode surface structures become more graphitic in Preparation Examples 3, 4, 11, and 12, suggesting that the pyrolysis performed at a temperature above 800° C. can further alter the surface structure of the cathode.

TABLE 5

| | XPS (at %) | | |
|---|---|---|---|
| | C | O | N |
| Preparation Example 7 | 95.09 | 3.42 | 1.49 |
| Preparation Example 8 | 93.38 | 3.41 | 3.21 |
| Preparation Example 9 | 95.43 | 2.84 | 1.73 |
| Preparation Example 3 | 95.35 | 2.44 | 2.22 |
| Preparation Example 4 | 93.90 | 2.82 | 3.28 |
| Preparation Example 10 | 95.06 | 3.00 | 1.94 |
| Preparation Example 11 | 94.50 | 3.19 | 2.31 |
| Preparation Example 12 | 94.06 | 3.13 | 2.81 |

Table 5 above shows the results of the XPS analysis conducted on Preparation Examples 3, 4, and 7 to 12.

Referring to Table 5 above, oxygen and nitrogen species are formed within the range from 2 at % to 4 at % in the Preparation Examples. Among these Preparation Examples, Preparation Example 4 shows the most significant amount of nitrogen species, from which it can be concluded that it is most desirable to form the positive electrode for the zinc-bromine aqueous battery containing 12% nitrogen-doped mesoporous carbon material at the pyrolysis temperature of 800° C.

TABLE 6

| | XPS N 1s (at %) | | | |
|---|---|---|---|---|
| | Oxidized N | Quaternary N | Pyrrolic N | Pyridinic N |
| | [402.4 eV] | [401 eV] | [400 eV] | [398.2 eV] |
| Preparation | 4.67 | 33.18 | 18.24 | 43.91 |
| Example 7 | | | | |
| Preparation | 3.29 | 30.54 | 16.76 | 49.40 |
| Example 8 | | | | |
| Preparation | 5.76 | 30.67 | 16.91 | 46.66 |
| Example 9 | | | | |
| Preparation | 3.97 | 32.70 | 21.53 | 41.80 |
| Example 3 | | | | |
| Preparation | 4.58 | 32.74 | 21.52 | 41.15 |
| Example 4 | | | | |
| Preparation | 3.68 | 42.38 | 16.86 | 37.09 |
| Example 10 | | | | |
| Preparation | 4.50 | 41.03 | 15.89 | 38.59 |
| Example 11 | | | | |
| Preparation | 5.15 | 41.08 | 15.28 | 38.50 |
| Example 12 | | | | |

To further analyze the nitrogen species in Table 5, XPS N is analysis was performed and presented in Table 6. It was observed that Preparation Examples 3, 4, and 7 to 12 contained more than 37 at % of pyridinic N. Pyridine nitrogen exhibits excellent properties for the adsorption of bromine and bromine compounds.

Therefore, it can be seen from Tables 5 and 6 that Preparation Examples 3, 4, and 7 to 12, containing more than 37 at % of pyridine nitrogen, can adsorb bromine and bromine complexes generated during battery operation, which helps inhibit the crossover of bromine, thereby improving the performance of the electrodes. Furthermore, since the content of pyridine nitrogen in Preparation Examples 3, 4, and 7 to 9 is more than 41 at %, the adsorption of bromine and bromine complexes may be further facilitated at the pyrolysis temperature ranging from 700° C. to 900° C. during the manufacturing of the cathode, potentially contributing to the improvement of the battery performance.

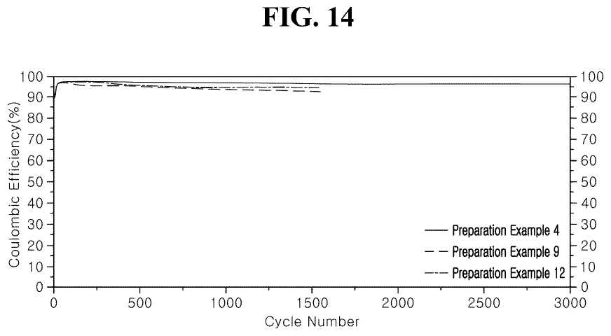

FIG. 14 is a graph showing the measured charge-discharge performance of the Preparation Examples depending on the pyrolysis temperature of the present inventive concept. The performance of Preparation Examples 9 and 12, which also contained the nitrogen-doped mesoporous carbon material, was measured based on Preparation Example 4, which exhibited the best performance at 800° C.

Referring to FIG. 14, Preparation Example 4 maintained its Coulombic efficiency of over 90% up to 3000 cycles, demonstrating excellent long-term stability. In Preparation Examples 9 and 12, the batteries were operated up to 1500 cycles, indicating that the long-term stability was lower than that of Preparation Example 4. However, the Coulombic efficiency of Preparation Examples 9 and 12 remained above 90% up to 1500 cycles, demonstrating excellent charge-discharge performance.

Therefore, it can be concluded that the charge-discharge performance of the battery is excellent at the pyrolysis temperature ranging from 700° C. to 900° C. and is even better when treated at 800° C.

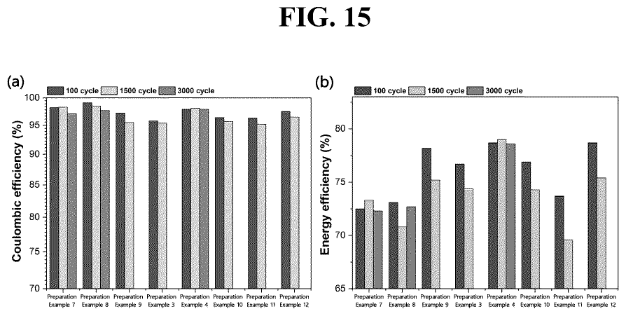

FIG. 15 depicts graphs showing the results of long-term stability and performance tests for the Preparation Examples of the present inventive concept depending on the pyrolysis temperature of the present inventive concept.

Referring to FIG. 15, (a) represents a graph showing the measured Coulombic efficiency, and (b) represents the measured energy efficiency. Referring to (a) in FIG. 15, the average Coulombic efficiency of the Preparation Examples remains above 95% after the initial 100 cycles, demonstrating excellent performance, and does not significantly decrease even after 1500 cycles. Moreover, Preparation Examples 4, 7, and 8 have the average Coulombic efficiency of over 97% up to 3000 cycles, demonstrating excellent long-term stability.

Referring to (b) in FIG. 15, the average Coulombic efficiency of the Preparation Examples remains above 72% after the initial 100 cycles, which is relatively low. However, compared to the Comparative Example in (b) of FIG. 15, the average energy of the Preparation Examples decreased only less than 5%, whereas the Comparative Example showed a decrease of 11.7% after 1500 cycles. Furthermore, it was confirmed that the average energy efficiency of Preparation Examples 4, 7, and 8 decreased to less than 1% even after 3000 cycles, demonstrating excellent performance.

Therefore, FIG. 15 shows that Preparation Examples 3, 4, and 7 to 12 exhibit excellent performances, and Preparation Examples 4, 7, and 8 show better results. Thus, it can be concluded that the best performance is achieved when the heat treatment temperature is 700° C. to 800° C. during manufacturing the positive electrode.

Therefore, according to the present inventive concept as described above, the positive electrode for the zinc-bromine aqueous battery containing the nitrogen-doped mesoporous carbon material of the present inventive concept modifies the structural and chemical properties of the graphite felt, thereby creating spaces for adsorption and storage of bromine and bromine complexes generated during battery operation. Therefore, it is possible to maintain the battery performance by inhibiting the crossover of bromine. Moreover, it is possible to achieve uniform coating using the evaporation-induced self-assembly (EISA) method for coating the porous carbon material onto the graphite felt.

Without the need for any pretreatment such as heat or ozone treatment to introduce functional groups containing oxygen atoms on the electrode surface to hydrophilize the conventional hydrophobic graphite felt electrode, the present inventive concept can enhance the affinity between the positive electrode and the aqueous electrolyte using nitrogen species and oxygen species within the nitrogen-doped mesoporous carbon material, thereby improving the potential stability of the battery.

Therefore, the present inventive concept exhibits higher performance and stability when evaluating the performance of individual batteries compared to the prior art.

While the inventive concept has been shown and described concerning certain preferred embodiments thereof, it will be understood by those skilled in the art that various changes in form and details may be made therein without departing from the spirit and scope of the inventive concept as defined by the appended claims. Therefore, the scope of the inventive concept is defined not by the detailed description of the inventive concept but by the appended claims, and all differences within the scope will be construed as being included in the present inventive concept.

What is claimed is:

1. A positive electrode for a zinc-bromine aqueous battery containing a nitrogen-doped mesoporous carbon material comprising:
a graphite felt; and
a nitrogen-doped mesoporous carbon material coated onto the graphite felt,
wherein the porous carbon material contains pyridine nitrogen in an amount of more than 41 at % in nitrogen species; and
wherein the porous carbon material includes two types of mesopores.

2. The positive electrode for the zinc-bromine aqueous battery containing the nitrogen-doped mesoporous carbon material of claim 1, wherein the porous carbon material has a solid content of 8% to 15% relative to the total weight.

3. The positive electrode for the zinc-bromine aqueous battery containing the nitrogen-doped mesoporous carbon material of claim 1, wherein the mesopores consist of a first type of pores and a second type of pores,
wherein the first type of pores has an average pore diameter ranging from 2.8 nm to 3.3 nm, and
wherein the second type of pores has an average diameter ranging from 5.3 nm to 6.0 nm.

4. The positive electrode for the zinc-bromine aqueous battery containing the nitrogen-doped mesoporous carbon material of claim 1, wherein the positive electrode comprises oxygen species and nitrogen species in the range of 2 at % to 4 at %, respectively.

5. The positive electrode for the zinc-bromine aqueous battery containing the nitrogen-doped mesoporous carbon material of claim 4, wherein the positive electrode exhibits hydrophilicity through the nitrogen and oxygen species.

6. A method of manufacturing the positive electrode for the zinc-bromine aqueous battery containing the nitrogen-doped mesoporous carbon material, the method comprising the steps of:
immersing graphite felt in a slurry containing a solvent, a pore-forming agent, a carbon precursor, a nitrogen source material, and a cross-linking agent;
coating the slurry onto the resulting graphite felt through the evaporation-induced self-assembly method, followed by drying;
curing the dried graphite felt; and
pyrolyzing the cured graphite felt to manufacture the positive electrode for the zinc-bromine aqueous battery containing the nitrogen-doped mesoporous carbon material,
wherein the porous carbon material includes two types of mesopores.

7. The method of manufacturing the positive electrode for the zinc-bromine aqueous battery containing the nitrogen-doped mesoporous carbon material of claim 6 further comprises pretreating the graphite felt before the pyrolyzing step.

8. The manufacturing method of the positive electrode for the zinc-bromine aqueous battery contains the nitrogen-doped mesoporous carbon material of claim 6, wherein the pyrolyzing step is carried out at a temperature ranging from 700° C. to 900° C.

9. The method of manufacturing the positive electrode for the zinc-bromine aqueous battery contains the nitrogen-doped mesoporous carbon material of claim 6, wherein the porous carbon material contains pyridine nitrogen in more than 41 at % of nitrogen species.

10. The method of manufacturing the positive electrode for the zinc-bromine aqueous battery containing the nitrogen-doped mesoporous carbon material of claim 6, wherein the amount of the pore-forming agent added is in the range from 2.5 wt % to 10.9 wt % relative to the amount of solvent.

11. The method of manufacturing the positive electrode for the zinc-bromine aqueous battery containing the nitrogen-doped mesoporous carbon material of claim 6, wherein the amount of the carbon precursor added is in the range from 2.0 wt % to 10.0 wt % relative to the amount of solvent.

12. The method of manufacturing the positive electrode for the zinc-bromine aqueous battery containing the nitrogen-doped mesoporous carbon material of claim 6, wherein the amount of the nitrogen source material added is in the range from 1.2 wt % to 6.7 wt % relative to the amount of solvent.

13. The method of manufacturing the positive electrode for the zinc-bromine aqueous battery containing the nitrogen-doped mesoporous carbon material of claim 6, wherein the amount of cross-linking agent added is in the range from 2.0 wt % to 10 wt % relative to the amount of solvent.

14. The method of manufacturing the positive electrode for the zinc-bromine aqueous battery containing the nitrogen-doped mesoporous carbon material of claim 6, wherein the composition of the nitrogen-doped mesoporous carbon material is calculated by Equation 1 below:
$$X \% = \frac{\begin{matrix}Solid mass ( Pore - forming agent + \\ Carbon precursor + Nitrogen source material )\end{matrix}}{\begin{matrix}Solid mass + \\ Cross - linking agent mass + Solvent mass\end{matrix}} * 100 \% \qquad [ Equation 1 ]$$
where X represents the solid content used in manufacturing the positive electrode.

15. The method of manufacturing the positive electrode for the zinc-bromine aqueous battery containing the nitrogen-doped mesoporous carbon material of claim 14, wherein the solid content ratio of the nitrogen-doped porous carbon material is in the range from 8% to 15% based on Equation 1 above.

16. The method of manufacturing the positive electrode for the zinc-bromine aqueous battery containing the nitrogen-doped mesoporous carbon material of claim 6,
wherein the mesopores consist of a first type of pores and a second type of pores, wherein the first type of pores has an average pore diameter ranging from 2.8 nm to 3.3 nm, and
the second type of pore has an average diameter ranging from 5.3 nm to 6.0 nm.
